(19) United States
(12) Patent Application Publication
(10) Pub. No.: US 2026/0360811 A1
(43) Pub. Date: Nov. 12, 2026

(54) POLYMER SOLID ELECTROLYTE COMPOSITION AND USE THEREOF

(71) Applicant: LOTTE CHEMICAL CORPORATION, Seoul (KR)

(72) Inventors: Young Min Baek, Seoul (KR); Sang Sun Park, Seoul (KR); Hyun Jin Jung, Seoul (KR); Se Ho Park, Seoul (KR); Mi Jin Jung, Seoul (KR)

(73) Assignee: LOTTE CHEMICAL CORPORATION, Seoul (KR)

(21) Appl. No.: 19/124,737

(22) PCT Filed: Nov. 15, 2023
(86) PCT No.: PCT/KR2023/018317

§ 371 Date: Apr. 25, 2025

(30) Foreign Application Priority Data
Nov. 6, 2022 (KR) 10-2022-0165198

(51) Int. Cl. H01M 10/0565; H01M 10/0525

(52) U.S. Cl. CPC H01M 10/0565; H01M 10/0525; H01M 2300/0082

(57) ABSTRACT

The present disclosure relates to a polymer solid electrolyte composition and a use thereof. The present disclosure can improve the electrical conductivity of a polymer solid electrolyte. In addition, the present disclosure can lower cell resistance when used in a lithium metal battery including a cathode having a specific composition.

### TECHNICAL FIELD

The present disclosure relates to a polymer solid electrolyte composition and a use thereof.

Particularly, the present disclosure relates to a polymer solid electrolyte composition, a polymer solid electrolyte, and a lithium secondary battery.

### BACKGROUND ART

Demand for secondary batteries is increasing in various fields, such as PCs, mobile phones, electric vehicles, and energy storage devices. Among secondary batteries, particularly, a lithium secondary battery has a higher capacity density than other secondary batteries and operates even at high voltages.

The lithium secondary battery generally consists of a cathode; an anode; and an electrolyte interposed between the cathode and the anode and containing a lithium salt. The electrolyte includes a non-aqueous liquid electrolyte or a solid electrolyte. The non-aqueous liquid electrolyte penetrates into the inside of the cathode. Therefore, the non-aqueous liquid electrolyte may provide high electrical performance by easily forming an interface between the active material of the cathode and the electrolyte.

However, the non-aqueous liquid electrolyte is vulnerable to ignition due to overcurrent and the like caused by short circuits, etc., by using flammable organic solvents. Therefore, the non-aqueous liquid electrolyte requires the installation of separate safety devices, selection of special battery materials, etc., and limits a battery structural design. This causes increased manufacturing costs and decreased productivity of the lithium secondary battery.

All-solid-state batteries replace liquid electrolytes with solid electrolytes. The all-solid-state batteries have no disadvantage of using flammable organic solvents. Therefore, the advantages of all-solid-state batteries are low manufacturing costs and excellent productivity. In addition, the all-solid-state batteries have a simple structure. Therefore, the advantages of the all-solid-state battery structure are excellent stability and high capacity and output.

Types of solid electrolytes include a sulfide solid electrolyte, an oxide solid electrolyte, a polymer solid electrolyte, and the like. The sulfide solid electrolyte and the oxide solid electrolyte need to be compressed at high temperature and pressure due to high interfacial resistance. It is advantageous that the polymer solid electrolyte may be manufactured under normal conditions (room temperature and pressure).

However, the disadvantage of the polymer solid electrolyte is insufficient electrical conductivity.

Patent Document 1 discloses the content of synthesizing a structure in which polyethylene glycol (PEG) is bound to poly(arylene ether sulfone) (PAES) and poly(arylene ether ketone) (PAEK), respectively, and preparing an electrolyte membrane using a THE solvent. The technology of Patent Document 1 has high interfacial resistance between the electrolyte membrane and the electrode. In addition, since Patent Document 1 prepares a polymer electrolyte using a solvent, it is difficult to directly form the electrolyte membrane on the electrode.

Non-patent document 1 discloses the content for RAFT polymerization of PEGMA and PEGDA on an electrode. Non-patent document 2 discloses a polymer solid electrolyte prepared by polymerizing PEGMEM, PEGMA, and POSS. However, the technologies of Non-Patent Document 1 and Non-Patent Document 2 are lacking in the ionic conductivity of the polymer solid electrolyte and the life of the battery manufactured using the polymer solid electrolyte.

### PRIOR ARTS

### Patent Documents

(Patent Document 1) Korean Patent Publication No. 10-2022-0039180 (Mar. 29, 2022)

### Non-Patent Documents

(Non-Patent Document 1) Ji Hu, “Poly(ethylene oxide)-based composite polymer electrolytes embedding with ionic bond modified nanoparticles for all-solid-state lithium-ion battery”, (2019) 200
(Non-Patent Document 2) Jinfang Zhang, “A star-shaped solid composite electrolyte containing multifunctional moieties with enhanced electrochemical properties for all solid-state lithium batteries”, (2018) 107

### DISCLOSURE

### Technical Problem

An object of the present disclosure is to improve the electrical conductivity of a polymer solid electrolyte.

Another object of the present disclosure is to improve the life of a lithium secondary battery.

### Technical Solution

According to an aspect of the present disclosure, a polymer solid electrolyte composition includes a first liquid including polyalkylene glycol (meth)acrylate, vinyl alkylene carbonate and polyfunctional (meth)acrylate; and a second liquid including a nitrile-based compound represented by Chemical Formula 1:

CN—X—CN [Chemical Formula 1]

In Chemical Formula 1, X is a substituted or unsubstituted, linear or branched alkylene group having 1 to 20 carbon atoms.

According to another aspect of the present disclosure, a polymer solid electrolyte includes a polymer matrix including a polyalkylene glycol (meth)acrylate-derived polymerization unit, a vinyl alkylene carbonate-derived polymerization unit, and a polyfunctional (meth)acrylate-derived polymerization unit; and a dispersion monomer dispersed in the polymer matrix and including a nitrile-based compound represented by Chemical Formula 1:

CN—X—CN [Chemical Formula 1]

In Chemical Formula 1, X is a linear or branched alkylene group having substituted or unsubstituted 1 to 20 carbon atoms.

According to yet another aspect of the present disclosure, a lithium secondary battery includes a solid electrolyte layer including a polymer solid electrolyte; a cathode layer disposed on one surface of the solid electrolyte layer; and an anode layer disposed on the opposite side of the cathode layer based on the solid electrolyte layer.

### Advantageous Effects

According to the present disclosure, it is possible to improve the electrical conductivity of a polymer solid electrolyte.

According to the present disclosure, it is possible to improve the life of a lithium secondary battery.

### DESCRIPTION OF DRAWINGS

FIG. 1 is a schematic diagram of a polymer solid electrolyte of the present disclosure.

FIG. 2 is a SEM photograph of an electrode-electrolyte interface produced in Example 1.

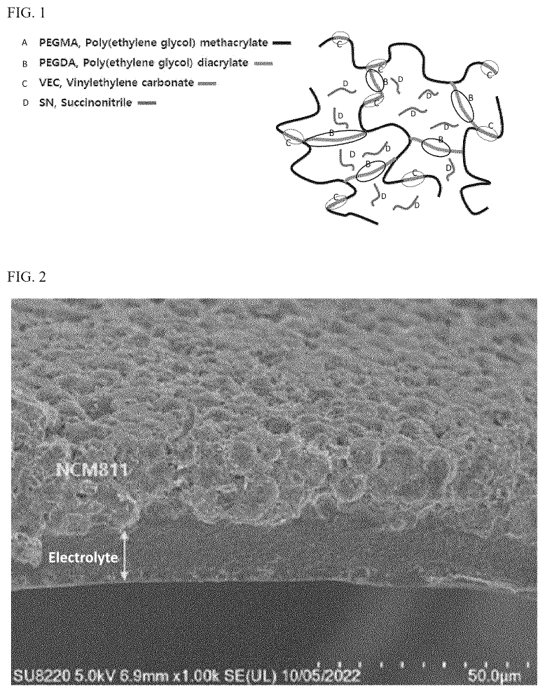

### MODES

### Polymer Solid Electrolyte Composition

One aspect of the present disclosure relates to a polymer solid electrolyte composition. The composition of the present disclosure may be dried to obtain a polymer solid electrolyte.

The composition of the present disclosure is a two-liquid composition. Here, when the polymer solid electrolyte is formed, one liquid becomes a matrix, and the other liquid becomes a phase dispersed in the matrix. Hereinafter, the former is called a first liquid and the latter is called a second liquid. In addition, if phases of each material at a temperature at which the composition of the present disclosure is prepared are liquids, the phases may be called first and second liquids, respectively. In other words, the first and second liquids are not necessarily liquids at room temperature.

The first liquid includes a monomer and/or polymer component having a specific composition, other additives, etc. Specifically, the first liquid includes polyalkylene glycol (meth)acrylate and vinyl alkylene carbonate.

The polyalkylene glycol (meth)acrylate constitutes a central skeleton of the matrix. The matrix allows the polymer solid electrolyte to have a free standing form.

In particular, the vinyl alkylene carbonate may be introduced into a main chain of the polymer in the polymer solid electrolyte by polymerization with the polyalkylene glycol (meth)acrylate. By introducing the vinyl alkylene carbonate into the main chain of the polymer, the stable performance of the battery may be maintained for a long period of time. That is, when the vinyl alkylene carbonate is introduced into the main chain of the polymer in the polymer solid electrolyte, the life of the battery may be increased.

In the present disclosure, (meth)acrylate is methacrylate or acrylate.

In the present disclosure, the alkylene group is a substituted or unsubstituted, linear or branched alkylene group having 1 to 20 carbon atoms.

The first liquid includes a cross-linking agent in addition to the components.

That is, the first liquid includes a material capable of forming a cross-linking structure between the polymers formed by the polyalkylene glycol (meth)acrylate and the vinyl alkylene carbonate.

Specifically, the first liquid includes polyfunctional (meth)acrylate as a cross-linking agent. The polyfunctional (meth)acrylate is a compound containing at least two (meth)acryloyl groups. The first liquid may form a rigid polymer matrix including polyfunctional (meth)acrylate. The first liquid may include the polyfunctional (meth)acrylate to prepare a polymer solid electrolyte that adheres to the cathode when bound to a cathode having a specific component. Specifically, the polyfunctional (meth)acrylate of the first liquid may penetrate into the inside of the cathode before polymerization, and when the monomer components penetrated above form a cross-linking structure, the adhesion between the polymer solid electrolyte layer and the electrode may be improved. When the polymer solid electrolyte and the electrode adhere to each other, the interfacial resistance between the electrode and the electrolyte decreases, resulting in a decrease in cell resistance of the battery.

The second liquid includes a compound having a specific structure as a monomer and disperses the monomers in the polymer matrix formed by the first liquid. In addition, these dispersed monomers improve the ionic conductivity of the polymer solid electrolyte. The second liquid includes a nitrile-based compound. Specifically, the second liquid includes a nitrile-based compound represented by Chemical Formula 1:

CN—X—CN [Chemical Formula 1]

In Chemical Formula 1, X is a substituted or unsubstituted, linear or branched alkylene group having 1 to 20 carbon atoms. Preferably, X is an unsubstituted alkylene group. Preferably, X is a linear alkylene group. Preferably, X is an alkylene group having 1 to 16 carbon atoms, 1 to 12 carbon atoms, 1 to 8 carbon atoms, 1 to 4 carbon atoms, or 1 to 2 carbon atoms. More preferably, X is an ethylene group.

The type of polyalkylene glycol (meth)acrylate is not limited, and among known components, components capable of forming the central skeletal structure of the polymer solid electrolyte may be used without limitation. Preferably, the polyalkylene glycol (meth)acrylate is polyethylene glycol methacrylate.

The properties of the polyalkylene glycol (meth)acrylate are also not limited. For example, the molecular weight of the polyalkylene glycol (meth)acrylate may be controlled within a specific range to prepare a rigid form of electrolyte membrane. Specifically, the number average molecular weight of the polyalkylene glycol (meth)acrylate may be in the range of 100 to 1000. The lower limit of the range may be 200, 300, 400, or 500. The upper limit of the range may be 900, 800, 700, 600, or 500.

The first liquid may include the polyalkylene glycol (meth)acrylate as a main component. The including of the specific component as the main component may mean that the content of the component is 50 wt % or more based on the total weight.

Accordingly, the content of the polyalkylene glycol (meth)acrylate may be in the range of 50 wt % to 90 wt % based on the total weight of the first liquid. The lower limit of the range (unit: wt %) may be 55, 60, or 65. The upper limit of the range (unit: wt %) may be 85, 80, 75, 70, or 65. A polymer solid electrolyte having a rigid structure may be prepared within the content range of the polyalkylene glycol (meth)acrylate.

The type of vinyl alkylene carbonate is not limited. The vinyl alkylene carbonate may be selected from components known to maintain stable performance of the battery for a long period of time. Preferably, the vinyl alkylene carbonate may be vinyl ethylene carbonate.

It is also preferable that the content of the vinyl alkylene carbonate is appropriately controlled. The content of the vinyl alkylene carbonate may be in the range of 10 parts by weight to 20 parts by weight with respect to 100 parts by weight of the polyalkylene glycol (meth)acrylate. Within the range, the stable performance of the battery may be appropriately maintained for a long period of time.

The type of polyfunctional (meth)acrylate is not limited. The polyfunctional (meth)acrylate may be selected from those having two or more (meth)acryloyl groups and capable of imparting an appropriate cross-linking structure to a polymer including the polyalkylene glycol (meth)acrylate and the vinyl alkylene carbonate. Preferably, the polyfunctional (meth)acrylate is polyalkylene glycol di(meth)acrylate. More preferably, the polyfunctional (meth)acrylate is polyethylene glycol diacrylate.

When the polyalkylene glycol di(meth)acrylate is used as the polyfunctional (meth)acrylate, its molecular weight may be appropriately controlled so that an electrolyte membrane having sufficient strength may be prepared. For example, the number average molecular weight of the polyfunctional (meth)acrylate may be in the range of 500 to 1500. The lower limit of the range may be 550, 600, 650, or 700. The upper limit of the range may be 1400, 1300, 1200, 1100, 1000, 900, 800, or 700.

The first liquid may further include known components necessary for producing other polymer solid electrolytes.

For example, since the first liquid forms a polymer of polyalkylene glycol (meth)acrylate and vinyl alkylene carbonate, the first liquid may further include a polymerization initiator.

The type of polymerization initiator is not limited. The polymerization initiator may be selected from components capable of initiating a conventional polymerization reaction. For example, the polymerization initiator may be selected from the group consisting of 2,2-azobisisobutyronitrile (AIBN), benzoyl peroxide, acetyl peroxide, lauryl peroxide, t-butyl peracetate, t-butyl hydroperoxide, and di-t-butyl peroxide.

Preferably, the polymerization initiator is 2,2-azobisisobutyronitrile.

It is also preferable that the content of the polymerization initiator is appropriately controlled. The content of the polymerization initiator may be in the range of 0.1 parts by weight to 1 part by weight with respect to 100 parts by weight of the polyalkylene glycol (meth)acrylate. Within the range, the polymerization reaction of the component in the first liquid may be appropriately initiated. The lower limit of the range (unit: parts by weight) may be 0.2, 0.3, 0.4, or 0.5. The upper limit of the range (unit: parts by weight) may be 0.9, 0.8, 0.7, 0.6, or 0.5.

The polymer solid electrolyte composition of the present disclosure may prepare a polymer solid electrolyte applied to a lithium secondary battery. Specifically, the polymer solid electrolyte composition of the present disclosure may prepare a polymer solid electrolyte applied to a lithium metal battery. Accordingly, the polymer solid electrolyte composition, specifically the first liquid, may further include a lithium salt.

The lithium salt may be, for example, LiPF₆, LiBF₄, LiCF₃SO₃, Li(CF₃SO₂)₂N, Li(CF₃SO₂)₃C, LiC₂F₅SO₃, Li(FSO₂)₂N, LiC₄F₉SO₃, LiN(SO₂CF₂CF₃)₂, LiN(CN)₂, etc. Preferably, the lithium salt is Li(CF₃SO₂)₂N.

The present disclosure does not limit the content of the lithium salt. The lithium salt may be added appropriately so that the electrolyte of the present disclosure exhibits sufficient activity. For example, the concentration of the lithium salt in the first liquid may be in the range of 0.5 M to 2 M. The lower limit of the range (unit: M) may be 0.6, 0.7, 0.8, 0.9, or 1.0. The upper limit of the range (unit: M) may be 1.9, 1.8, 1.7, 1.6, 1.5, 1.4, 1.3, 1.2, 1.1, or 1.0.

Preferably, the composition of the second liquid is also controlled.

As described above, it is preferred that X in Chemical Formula 1 is ethylene. That is, the nitrile-based compound is preferably succinonitrile.

The second liquid may contain the nitrile-based compound as a main component. The including of the specific component as the main component may mean that the content of the component is 50 wt % or more based on the total weight.

Accordingly, the content of the nitrile-based compound may be in the range of 50 wt % to 90 wt % with respect to the total weight of the second liquid. The lower limit of the range (unit: wt %) may be 55, 60, 65, or 70. The upper limit of the range (unit: wt %) may be 85, 80, or 75. The ionic conductivity of the polymer solid electrolyte may be improved within the content range of the nitrile-based compound.

The second liquid may further include an additive to enable the nitrile-based compound to be better dispersed in the polymer solid electrolyte. The additive may be, for example, fluoroalkylene carbonate.

That is, the second liquid may further include fluoroalkylene carbonate. The fluoroalkylene carbonate may form a type of protective layer called Solid Electrolyte Interphase (SEI) between the anode and the polymer electrolyte during an initial charging/discharging process of a battery using a polymer electrolyte. The protective layer formed above may improve the operating performance and life of the battery.

The type of fluoroalkylene carbonate is also not limited. The fluoroalkylene carbonate may be selected from components known to play a role in appropriately dispersing components such as the nitrile-based compound into a polymer matrix. Preferably, the fluoroalkylene carbonate is fluoroethylene carbonate.

The content of the fluoroalkylene carbonate may also be appropriately controlled. For example, the content of the fluoroalkylene carbonate may be in the range of 1 part by weight to 10 parts by weight with respect to 100 parts by weight of the nitrile-based compound. The lower limit of the range (unit: parts by weight) may be 2, 3, 4, or 5. The upper limit of the range (unit: parts by weight) may be 9, 8, 7, 6, or 5. Within the range, the function of the SEI formed with the fluoroalkylene carbonate may be maximized.

As described above, the polymer solid electrolyte composition of the present disclosure may prepare a polymer solid electrolyte applied to a lithium secondary battery. Specifically, the polymer solid electrolyte composition of the present disclosure may prepare a polymer solid electrolyte applied to a lithium metal battery. Accordingly, the polymer solid electrolyte composition, specifically the second liquid, may further include a lithium salt, like the first liquid.

The lithium salt may be, for example, LiPF₆, LiBF₄, LiCF₃SO₃, Li(CF₃SO₂)₂N, Li(CF₃SO₂)₃C, LiC₂F₅SO₃, Li(FSO₂)₂N, LiC₄F₉SO₃, LiN(SO₂CF₂CF₃)₂, LiN(CN)₂, etc. Preferably, the lithium salt is Li(CF₃SO₂)₂N.

The present disclosure does not limit the content of lithium salt. The lithium salt may be added appropriately so that the electrolyte of the present disclosure exhibits sufficient activity. For example, the concentration of the lithium salt in the second liquid may be in the range of 0.5 M to 2 M. The lower limit of the range (unit: M) may be 0.6, 0.7, 0.8, 0.9, or 1.0. The upper limit of the range (unit: M) may be 1.9, 1.8, 1.7, 1.6, 1.5, 1.4, 1.3, 1.2, 1.1, or 1.0.

The mixing ratio of the first liquid and the second liquid may also be appropriately controlled. For example, the weight ratio (A/B) of the first liquid (A) and the second liquid (B) may be in the range of 2 to 4. Within the range, the bonding strength between the polymer solid electrolyte and the electrode, the ionic conductivity of the polymer solid electrolyte, and the performance of the battery may be sufficiently secured.

The present disclosure may be a solvent-free composition. Specifically, the first liquid and the second liquid may be solvent-free compositions. That is, the first liquid and the second liquid may not contain a solvent. The present disclosure does not cause deformation of the electrolyte, such as pinholes, due to solvent volatilization (or evaporation by heating). At this time, the present disclosure may obtain an electrolyte membrane having a more uniform thickness and improved bonding strength with the electrode.

When the polymer solid electrolyte composition of the present disclosure prepared with the content is treated by a method such as heating at a predetermined temperature, a polymer solid electrolyte may be obtained.

### Polymer Solid Electrolyte

Another aspect of the present disclosure relates to a polymer solid electrolyte.

The polymer solid electrolyte of the present disclosure includes at least a polymer matrix and dispersion monomers dispersed in the polymer matrix.

In the polymer solid electrolyte of the present disclosure, the composition of each of the polymer matrix and the dispersed monomers is controlled.

The polymer matrix includes a polyalkylene glycol (meth)acrylate-derived polymerization unit, a vinyl alkylene carbonate-derived polymerization unit, and a polyfunctional (meth)acrylate-derived polymerization unit.

The dispersion monomer includes a nitrile-based compound represented by Chemical Formula 1:

CN—X—CN [Chemical Formula 1]

In Chemical Formula 1, X is a substituted or unsubstituted, linear or branched alkylene group having 1 to 20 carbon atoms.

If there are components mentioned in the aforementioned polymer solid electrolyte composition, the components may also be applied as they are to the polymer solid electrolyte.

In addition, the polymer solid electrolyte may include the polymer solid electrolyte composition described above. In addition, the polymer solid electrolyte may be derived from the polymer solid electrolyte composition described above.

Alternatively, the polymer solid electrolyte may be formed from the polymer solid electrolyte composition described above. Alternatively, the polymer solid electrolyte may be a cured or dried product of the polymer solid electrolyte composition described above.

The polymer solid electrolyte with the specific component as described above has a rigid appearance. In addition, this polymer electrolyte also has excellent electrical conductivity.

As described above, the polyfunctional (meth)acrylate is used as a cross-linking agent. Accordingly, in the polymer solid electrolyte, the polyfunctional (meth)acrylate may form a cross-linking structure. The cross-linking structure may improve the electrical conductivity of the polymer solid electrolyte.

Specifically, the polymer matrix may have a structure in which the polymer is cross-linked with a cross-linking agent. More specifically, in the polymer matrix, a polymer including the polyalkylene glycol (meth)acrylate-derived polymerization unit and the vinyl alkylene carbonate-derived polymerization unit may be cross-linked with the polyfunctional (meth)acrylate-derived polymerization unit. The cross-linking structure may improve adhesion to the electrode in the battery.

The polymer solid electrolyte of the present disclosure may be applied to a lithium secondary battery. Accordingly, components additionally included in the first liquid and/or second liquid described above, such as a lithium salt and/or fluoroalkylene carbonate, may be included in the polymer solid electrolyte. The type and content thereof also follow the aforementioned contents.

In particular, when the second liquid described above further includes fluoroalkylene carbonate, the polymer solid electrolyte of the present disclosure may significantly contribute to improving the battery life. As described above, the fluoroalkylene carbonate may form a type of protective layer called Solid Electrolyte Interphase (SEI) between the anode and the polymer electrolyte during an initial charging/discharging process of a battery using a polymer electrolyte. The protective layer formed above may improve the operating performance and life of the battery.

In addition, the fluoroalkylene carbonate is dispersed in the polymer matrix, like the nitrile-based compound in the polymer solid electrolyte.

### Lithium Secondary Battery

Yet another aspect of the present disclosure relates to a lithium secondary battery. Specifically, the lithium secondary battery of the present disclosure is an all-solid-state battery. More specifically, the lithium secondary battery of the present disclosure is an all-solid-state battery that uses the polymer solid electrolyte of the present disclosure as an electrolyte.

Accordingly, the lithium secondary battery of the present disclosure includes a solid electrolyte layer including the polymer solid electrolyte; a cathode layer disposed on one surface of the solid electrolyte layer; and an anode layer disposed on the opposite side of the cathode layer based on the solid electrolyte layer.

When describing the lithium secondary battery of the present disclosure, unless otherwise specifically limited, all components necessary to describe its structure may be appropriately selected from known components.

The polymer solid electrolyte of the present disclosure is particularly suitable for a lithium metal battery. The lithium metal battery is a lithium secondary battery that includes lithium metal as an anode material.

In addition, the polymer solid electrolyte of the present disclosure is suitable for a lithium metal battery having a particularly specified composition of a cathode material. At this time, the polymer solid electrolyte adheres to the cathode to significantly reduce the cell resistance.

For example, the cathode layer may include a compound represented by the following Chemical Formula 2, and the anode layer may be a lithium metal battery including lithium metal:

LiNiₐCo_{b}Mn_{c}O₂ (0.6≤a≤0.9, a+b+c=1). [Chemical Formula 2]

Preferably, in Chemical Formula 2, a is close to 0.8, and b and c are each close to 0.1.

When the cathode layer includes the compound and the anode layer includes lithium metal, the life improvement effect of the battery may be maximized, if the polymer solid electrolyte adheres to the cathode.

Hereinafter, the present disclosure will be described in detail by Examples.

However, the present disclosure is not limited to the following Examples.

### [Material Information]

PEGMA (Poly(ethylene glycol) methacrylate): Mn 500, Sigma-Aldrich
VEC (Vinylethylene carbonate): Sigma-Aldrich
PEGDA (Poly(ethylene glycol) diacrylate): Mn 700, Sigma-Aldrich
SN (Succinonitrile): Sigma-Aldrich
LiTFSI: Sigma-Aldrich
FEC (fluoroethylene carbonate): Sigma-Aldrich

### [Example 1] Polymer Solid Electrolyte Composition

### (1) First Liquid

2 g of PEGMA, 0.2 g of PEGDA, 0.2 g of VEC, and 0.65 g of LiTFSI were added on a hot plate and mixed at 30 °C for 2 hours. Next, 0.01 g of AIBN was added on the hot plate and mixed for 1 hour to prepare a first liquid. At this time, the concentration of LiTFSI was 1 M.

### (2) Second Liquid

2 g of SN, 0.1 g of FEC, and 0.58 g of LiTFSI were added on a hot plate and mixed at 50 °C for 3 hours to prepare a second liquid. At this time, the concentration of LiTFSI was 1 M.

### (3) Mixing

The first liquid and the second liquid were mixed in a weight ratio of 3:1 and mixed at 40 °C for 1 hour to prepare a polymer solid electrolyte composition.

### [Example 2] Polymer Solid Electrolyte Composition

The same process as Example 1 was repeated, except that the first and second liquids were mixed in a weight ratio of 4:1.

### [Example 3] Polymer Solid Electrolyte Composition

The same process as Example 1 was repeated, except that the first and second liquids were mixed in a weight ratio of 2:1.

### [Example 4] Polymer Solid Electrolyte Composition

The same process as Example 1 was repeated, except that the content of PEGDA was changed to 20 parts by weight with respect to 100 parts by weight of PEGMA.

### [Comparative Example 1] Polymer Solid Electrolyte Composition

The same process as Example 1 was repeated, except that the second liquid was not used.

### [Comparative Example 2] Polymer Solid Electrolyte Composition

The same process as Example 1 was repeated, except that PEGDA was not used in the preparation of the first liquid.

### [Comparative Example 3] Polymer solid electrolyte composition

The same process as Example 1 was repeated, except that VEC was not used in the preparation of the first liquid.

### [Experimental Example 1] SEM Photography

The polymer solid electrolyte composition of Example 1 was coated on an NCM811 electrode (Loading amount: 6 mg/cm²) using an aluminum foil as a substrate. Next, the electrode was heated in a 100 °C oven for 2 hours to prepare a polymer solid electrolyte-electrode assembly.

The cross-section of the polymer solid electrolyte-electrode assembly was cut using liquid nitrogen. Next, the cross-section was analyzed using SEM (HITACHI SU-8220).

FIG. 2 shows results of Experimental Example 1 (SEM photograph). Through this, it may be confirmed that the bonding between the polymer solid electrolyte and the electrode is well formed.

### [Experimental Example 2] Evaluation of Coin Cell Resistance

### 1) NCM811-Electrolyte Adhesive Structure

In Examples and Comparative Examples, the polymer solid electrolyte composition was coated on an NCM811 electrode (Loading amount: 6 mg/cm²) using an aluminum foil as a substrate. Next, the electrode was heated in a 100 °C oven for 2 hours to prepare a polymer solid electrolyte-electrode assembly. Here, a 2032 coin cell composed of NCM811-electrolyte-Li metal was manufactured by positioning a 200 μm-thick Li metal electrode as an anode on the opposite side of the electrode based on the polymer solid electrolyte, and its internal resistance was evaluated. The diameters of the Li metal electrode and the NCM811 electrode were each 16 mm. MP1 from Wonatek was used as impedance measuring equipment. The measurement conditions were room temperature and a frequency range of 1 Hz to 1 MHz.

### 2) NCM811-Electrolyte Non-Adhesive Structure

Further, the polymer solid electrolyte composition of Example 1 was coated on a glass plate and then heated in a 100 °C oven for 2 hours to prepare a polymer solid electrolyte membrane.

The solid electrolyte membrane was added between a 200 μm-thick Li metal electrode and an NCM811 electrode (Loading amount: 6 mg/cm²) using an aluminum foil as a substrate, and pressed to prepare a 2032 coin cell composed of NCM811-electrolyte-Li metal, and its internal resistance was evaluated. The diameters of the Li metal electrode and the NCM811 electrode were each 16 mm. MP1 from Wonatek was used as impedance measuring equipment. The measurement conditions were room temperature and a frequency range of 1 Hz to 1 MHz.

### [Experimental Example 3] Evaluation of Ionic Conductivity

In Examples and Comparative Examples, the polymer solid electrolyte was coated on a 200 μm-thick Li metal electrode. Next, the electrode was heated in a 100 °C oven for 2 hours to prepare a polymer solid electrolyte-electrode assembly. Here, a 2032 coin cell composed of Li metal-electrolyte-Li metal was manufactured by positioning a 200 μm-thick Li metal electrode as an anode on the opposite side of the electrode based on the polymer solid electrolyte, and its internal resistance was evaluated. The diameters of both electrodes were 16 mm, respectively. MP1 from Wonatek was used as impedance measuring equipment. The measurement conditions were room temperature and a frequency range of 1 Hz to 1 MHz.

### [Experimental Example 4] Evaluation of Battery Life

The battery life was evaluated at room temperature for the coin cell prepared in Experimental Example 2. Charging/discharging was performed at 0.3 C, and at this time, the voltage range was 3.0 V to 4.3 V. The battery life was calculated through a discharge retention rate. Specifically, the number of charge/discharge cycles at which the discharge amount became 80% of an initial battery discharge amount was defined as the battery life.

### Results

Table 1 shows results of evaluating the ionic conductivity of polymer solid electrolytes and the resistance of lithium secondary batteries (coin cells) in Examples and Comparative Examples.

TABLE 1

| | | | | | Com. | Com. | Com. |
|---|---|---|---|---|---|---|---|
| Classification | Ex. 1 | Ex. 2 | Ex. 3 | Ex. 4 | Ex. 1 | Ex. 2 | Ex. 3 |
| Ionic | 6.5 × 10⁻⁴ | 4.1 × 10⁻⁴ | 8.1 × 10⁻⁴ | 4.8 × 10⁻⁴ | 0.9 × 10⁻⁴ | — | 6.2 × 10⁻⁴ |
| conductivity | | | | | | | |
| [S/cm] | | | | | | | |
| Coin-cell | 2.2 | 3.1 | 1.8 | 2.7 | 15.5 | — | 2.8 |
| resistance | (9.7)¹⁾ | | | | | | |
| [Ω] | | | | | | | |
| Coin-cell life | 140 | | | | | | 80 |
| [Cycle] | | | | | | | |

¹⁾Evaluation results for 2032 coin cell composed of NCM811-electrolyte-Li metal with NCM811-electrolyte non-adhesive structure

In Examples and Comparative Examples, it may be confirmed that the electrical conductivity of the polymer solid electrolyte defined in the present disclosure is higher, and the cell resistance of the lithium secondary battery manufactured by the polymer solid electrolyte is improved (reduced). When confirming the additional evaluation result for Example 1 (indicated in parentheses in the results of Table 1), it may be seen that the life of the battery may be further improved due to a structure in which the electrolyte adheres to a cathode having a specific composition. As in Comparative Example 1, it may be seen that if the polymer solid electrolyte is not prepared with a two-liquid composition having a specific composition, the electrical conductivity is lowered and the cell resistance is poor. In Comparative Example 2, since a rigid polymer solid electrolyte was not prepared, additional evaluation could not be performed. Through the results of Comparative Example 3, it may be seen that the battery life is reduced because a specific monomer is not introduced into the polymer structure.

1. A polymer solid electrolyte composition comprising:
a first liquid including polyalkylene glycol (meth)acrylate, vinyl alkylene carbonate and polyfunctional (meth)acrylate; and
a second liquid including a nitrile-based compound represented by Chemical Formula 1:
CN—X—CN [Chemical Formula 1]
In Chemical Formula 1, X is a substituted or unsubstituted, linear or branched alkylene group having 1 to 20 carbon atoms.

2. The polymer solid electrolyte composition of claim 1, wherein the polyalkylene glycol (meth)acrylate is polyethylene glycol methacrylate.

3. The polymer solid electrolyte composition of claim 1, wherein the number average molecular weight of the polyalkylene glycol (meth)acrylate is in the range of 100 to 1000.

4. The polymer solid electrolyte composition of claim 1, wherein the content of the polyalkylene glycol (meth)acrylate is in the range of 50 wt % to 90 wt % based on the total weight of the first liquid.

5. The polymer solid electrolyte composition of claim 1, wherein the vinyl alkylene carbonate is vinyl ethylene carbonate.

6. The polymer solid electrolyte composition of claim 1, wherein the content of the vinyl alkylene carbonate is in the range of 10 parts by weight to 20 parts by weight with respect to 100 parts by weight of the polyalkylene glycol (meth)acrylate.

7. The polymer solid electrolyte composition of claim 1, wherein the polyfunctional (meth)acrylate is polyalkylene glycol di(meth)acrylate.

8. The polymer solid electrolyte composition of claim 7, wherein the polyfunctional (meth)acrylate is polyethylene glycol diacrylate.

9. The polymer solid electrolyte composition of claim 7, wherein the number average molecular weight of the polyalkylene glycol di(meth)acrylate is in the range of 500 to 1500.

10. The polymer solid electrolyte composition of claim 1, wherein in Chemical Formula 1, X is an ethylene group.

11. The polymer solid electrolyte composition of claim 1, wherein the content of the nitrile-based compound is in the range of 50 wt % to 90 wt % based on the total weight of the second liquid.

12. The polymer solid electrolyte composition of claim 1, further comprising:
fluoroalkylene carbonate in the range of 1 part by weight to 10 parts by weight with respect to 100 parts by weight of the nitrile-based compound.

13. The polymer solid electrolyte composition of claim 12, wherein the fluoroalkylene carbonate is fluoroethylene carbonate.

14. The polymer solid electrolyte composition of claim 1, wherein a weight ratio (A/B) of the first liquid (A) and the second liquid (B) is in the range of 2 to 4.

15. A polymer solid electrolyte comprising:
a polymer matrix including a polyalkylene glycol (meth)acrylate-derived polymerization unit, a vinyl alkylene carbonate-derived polymerization unit, and a polyfunctional (meth)acrylate-derived polymerization unit; and
a dispersion monomer dispersed in the polymer matrix and including a nitrile-based compound represented by Chemical Formula 1:
CN—X—CN [Chemical Formula 1]
In Chemical Formula 1, X is a substituted or unsubstituted, linear or branched alkylene group having 1 to 20 carbon atoms.

16. The polymer solid electrolyte of claim 15, wherein a polymer including the polyalkylene glycol (meth)acrylate-derived polymerization unit and the vinyl alkylene carbonate-derived polymerization unit is cross-linked with the polyfunctional (meth)acrylate-derived polymerization unit.

17. The polymer solid electrolyte of claim 16, further comprising:
fluoroalkylene carbonate dispersed in the polymer matrix.

18. A lithium secondary battery comprising:
a solid electrolyte layer including the polymer solid electrolyte according to claim 15;
a cathode layer disposed on one surface of the solid electrolyte layer; and
an anode layer disposed on the opposite side of the cathode layer based on the solid electrolyte layer.
